(19) United States
(12) Patent Application Publication
(10) Pub. No.: US 2005/0081533 A1
(43) Pub. Date: Apr. 21, 2005

(54) Air-density increasing device for an electronic apparatus

(75) Inventors: Bang-Ji Wang, Taipei (TW); Chang-Chien Li, Hsin Chuan City (TW)

Correspondence Address: Ladas & Parry, 26 West 61st Street, New York, NY, 10023, US

(73) Assignee: BENQ CORPORATION

(21) Appl. No.: 10/889,540

(22) Filed: Jul. 12, 2004

(30) Foreign Application Priority Data
Oct. 21, 2003 (TW) 92129123

(51) Int. Cl. F25B 21/02; F02G 1/00; F02C 7/00; F02G 3/00; F25D 23/12; F25D 17/06

(52) U.S. Cl. 62/3.2; 62/259.2; 62/426

(57) ABSTRACT

An air-density increasing device is mounted an electronic apparatus having an air inlet, an air outlet and an exhaust face at the air outlet. When the exhaust fan is actuation, external air flows into the apparatus through the air-density increasing device and the air therewithin is expel via the air outlet. The amount of air flowing into the apparatus is greater than the amount of air flowing out of the apparatus by virtue of the air-density increasing device.

### FIELD OF THE INVENTION

The invention relates to an electronic apparatus, such as an image projector or a computer CPU, more particularly to an electronic apparatus having an air-density increasing device to increase air density within the electronic apparatus and to enhance ventilation of the electronic apparatus.

### BACKGROUND OF THE INVENTION

In order to provide more conveniences to the consumers, some electronic apparatuses are provided with multifunction. A conventional image projector of the past is generally bulky in size and is relatively heavy in weight. As the advance of electronic technology, more and more electronic apparatuses are constructed in compact size, and have a plurality of components for providing different functions. The heat resulting from operation of these components is subsequently increased, which in turn, hinder stability and smooth functioning of these components.

A heat-dissipating fan is generally mounted at an air outlet of the conventional image projector to dissipate heat therefrom upon actuation thereof. The conventional image projector can be provided with a plurality of heat dissipating fans and a plurality of air outlets into order to enhance the heat dissipating effect. However, such arrangement will result in undesired noises around the ambient surrounding of the conventional image projector.

### SUMMARY OF THE INVENTION

The object of the present invention is to provide an air-density increasing device for use in an electronic apparatus that can eliminate the aforesaid disadvantage of the prior electronic apparatus.

In one aspect of the present invention, an electronic apparatus is proposed and includes: an outer casing having an air inlet and an air outlet; an exhaust fan mounted on the outer casing adjacent to the air outlet for drawing out air from the outer casing; and an air-density increasing device mounted on the outer casing adjacent to the air inlet to enable the amount of air flowing into the air inlet to be greater than the amount of air that flows out of the air outlet, thereby increasing the density of air within the outer casing.

In another aspect of the present invention, an air-density increasing device for an electronic apparatus is proposed to increase the density of air within the electronic apparatus. The electronic apparatus has an air inlet, an air outlet, and an exhaust fan disposed adjacent to the air outlet. The air-density increasing device is disposed at the air inlet, wherein activation of the exhaust fan ventilates the electronic apparatus, and causes air to flow into the electronic apparatus via the air-density increasing device to increase the density of air within the electronic apparatus and so as to expel air via the exhaust fan. The air-density increasing device accordingly includes: an external casing enclosing components of the air-density increasing device; an air entrance which has at least one opening at a first end of the external casing for permitting air to flow thereinto; a pressure increasing system for causing the amount of air flowing into the air inlet to be greater than the amount of air flowing out from the air outlet so as to increase the density of air within the electronic apparatus; and a passage that is defined by at least one opening disposed at a second end of the external casing and that communicates with the air inlet so as to permit air flow into the electronic apparatus via the pressure increasing system.

### BRIEF DESCRIPTION OF THE DRAWING

Other features and advantages of this invention will become more apparent in the following detailed description of the preferred embodiments of this invention, with reference to the accompanying drawings, in which:

FIG. 1 is a perspective view the first preferred embodiment of an air-density increasing device according to the present invention mounted on an electronic apparatus;

FIG. 2 shows a sectional view of a thermoelectric cooling chip used in the first preferred embodiment;

FIG. 3 is a perspective view of the second preferred embodiment of an air-density increasing device according to the present invention;

FIG. 4 is a perspective view of the third preferred embodiment of an air-density increasing device according to the present invention; and

FIG. 5 is a perspective with of an image projector, within which the fourth preferred embodiment of an air-density increasing device of the present invention is built in.

### DETAILED DESCCRIPTIONS OF THE PREFERRED EMBODIMENTS

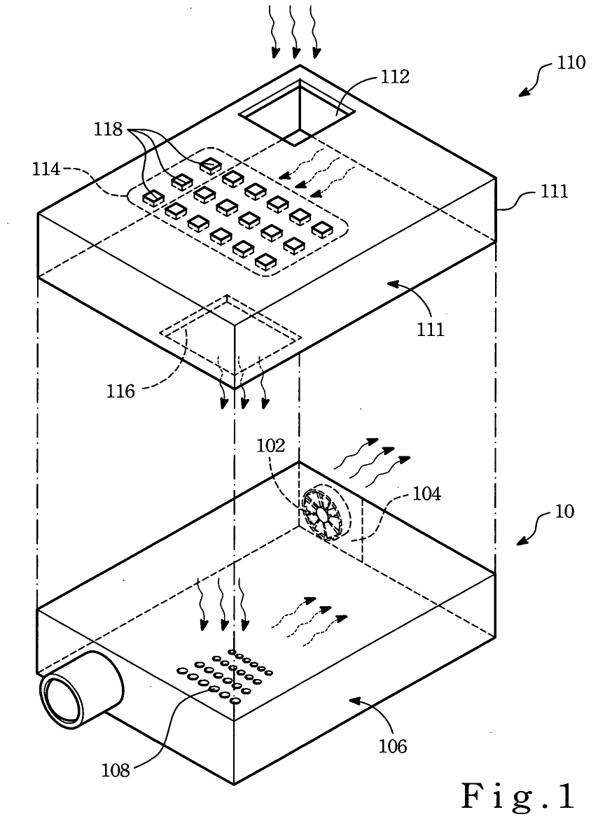

Referring to FIG. 1, the first preferred embodiment of an air-density increasing device 110 according to the present invention is used in an electronic apparatus 10, such as an image projector, to enhance ventilation thereof so as to enhance the heat dissipation effect of the electronic apparatus 10.

As illustrated, the electronic apparatus 10 includes an outer casing 106 formed with an air inlet 108 at one end thereof and an air outlet 104 at the other end thereof. An exhaust fan 102 is mounted on the outer casing 106 adjacent to the air outlet 104 for drawing out air from the outer casing 106 upon actuation thereof, thereby expelling the heat from within the outer casing 106. However, actuation of the exhaust fan 102 generates undesired noises.

The air-density increasing device 110 of the present invention is mounted on the outer casing 106 of the electronic apparatus 10 to enable the amount of air flowing into the air inlet 108 to be greater than the amount of air that flows out of the air outlet 104, thereby increasing the density of air within the outer casing 106. The air-density increasing device 110 preferably includes an external casing 111, and a pressure increasing system 114, and a passage 116. The external casing 111 is disposed on the outer casing 106 to enclose components therein, and has an air entrance 112 which is in the form of at least one opening at a first end of the external casing 111 for permitting air to flow into the external casing 111. The pressure increasing system 114 preferably includes a plurality of thermoelectric cooling chips 118 or thermoelectric cooling module to lower the temperature of air passing therethrough and to reduce the volume of the air, which in turn, increase the air density within the external casing 111. The passage 116 is defined by an opening that is disposed at a second end of the external casing 11 and that is in spatial communication with the air inlet 108 of the outer casing 106. Thus upon actuation of the exhaust fan 102, the air flows into the external casing 111 and the outer casing 106 in the direction as shown by three headed arrows in FIG. 1.

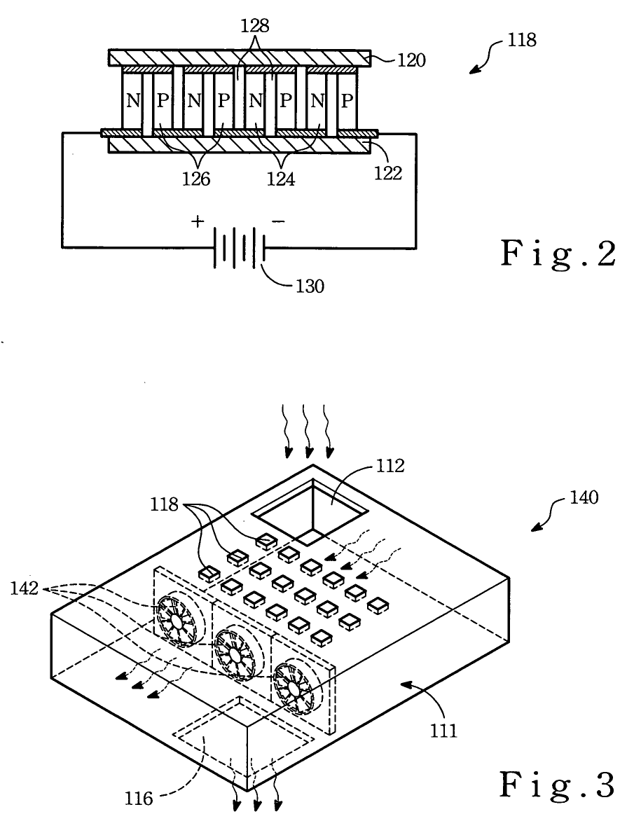

In the first preferred embodiment, three rows of thermoelectrical chips 118 are mounted on the external casing 111. Each of the thermoelectrical chips 118 (see FIG. 2) includes a cool ceramic end 120, a hot ceramic end 122, a plurality of N-type semiconductor members 124, a plurality of P-type semiconductor members 126, a plurality of conductors 128 and a direct current source 130. The N-type and P-type semiconductor members 124,126 are arranged in series while each of the conductors 128 is disposed between an adjacent pair of the N-type and P-type semiconductor members 124,126. Brass, aluminum or other metal can be used as the conductors 128. Preferably, the semiconductor members 124,126 and the conductors 128 are sandwiched between the cool and hot ceramic ends 120, 122. The direct current source 130 is electrically connected to the thermoelectrical chips 118 such that when current flows through the respective thermoelectrical chip 118, the volume of the air within the external casing 111 and the outer casing 106 is reduced by virtue of the chips 118, thereby increasing the air density therewithin and subsequently lowering the temperature within the external casing 111 and the outer casing 106. Under this condition, the amount of air flowing into the external casing 110 via the air entrance 112 is great than the amount of flowing out from the outer casing 106 via the air outlet 104. In this embodiment, the P-type semiconductor members 126 absorb the heat while the N-type semiconductor members 124 dissipate the absorbed heat via the hot ceramic end 122.

An important aspect to note that no extra exhaust fan 102 is required herein to enhance the heat dissipating effect and therefore there is no noise generated. Each of the thermoelectrical chips 118 is compact in size, and maintains a long service life, and therefore does not cause pollution to the environment. Mounting orientation of the thermoelectrical chips 118 on or within the external casing 111 is not restricted. In addition, it is convenient to employ the thermoelectrical chips 118 in the air-density increasing device of the present invention since no routine maintaining service is required to be conducted. In the event, a predetermined location of the electronic apparatus 10 is terribly hot due to heat dissipation of a particular component, a guide passage can be arranged at adjoining position of the passage 116 and the air inlet 108 so as to guide air into the predetermined location to increase the air density thereat.

Referring to FIG. 3, the second preferred embodiment of an air-density increasing device 140 of the present invention is shown to have a similar construction to the first preferred embodiment, except that at least one suction fan unit 142 is provided within the external casing 111 between the thermoelectrical chips 118 and the passage 116 so as to draw external air into the external casing 111, thereby increasing the volume of air flowing into the air entrance 112. Under this condition, the amount of air flowing into the electronic apparatus (not shown) is greater than the amount of air flowing out from the electronic apparatus (not shown). The presence of the suction fan unit 142 enhances the heat dissipating effect of the electronic apparatus.

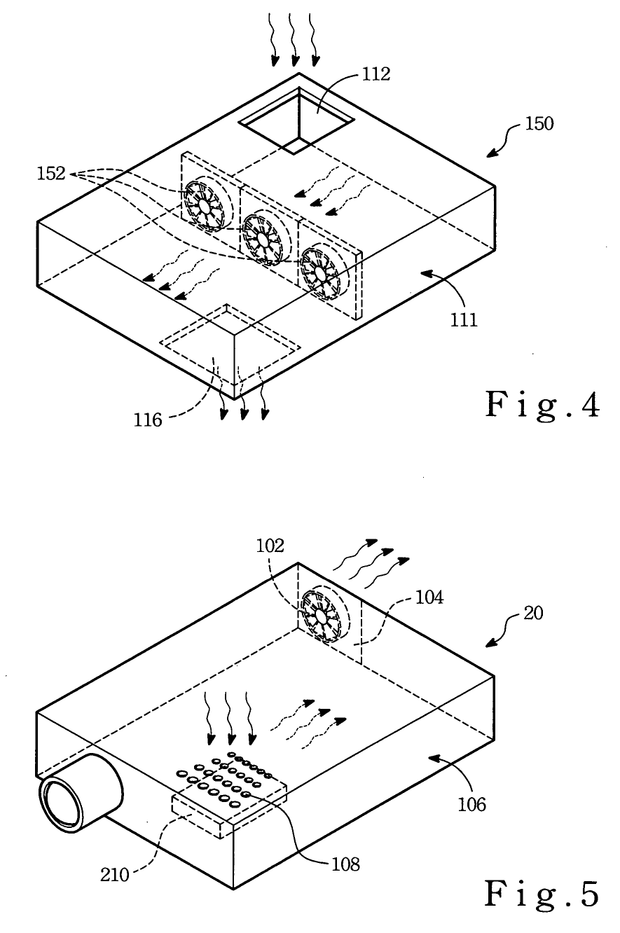

Referring to FIG. 4, the third preferred embodiment of an air-density increasing device 150 according to the present invention is shown to exclude the thermoelectrical chips but rather include a suction fan unit 152 provided within the external casing 111 between the air entrance 112 and the passage 116 so as to draw external air into the external casing 111, thereby increasing the volume of air flowing into the air entrance 112. Under this condition, the amount of air flowing into the electronic apparatus (not shown) is greater than the amount of air flowing out from the electronic apparatus (not shown).

An important aspect of the present invention is that small power suction fan units 142, 152 can be selected through arrangement in the second and third preferred embodiments in order to reduce the noise but can enhance the heat dissipating effect of the electronic apparatus.

Referring to FIG. 5, the fourth preferred embodiment of an air-density increasing device 210 according to the present invention is built within the outer casing 106 of the electronic apparatus 20. Therefore, no external casing is required for the air-density increasing device 210. However, the pressure increasing system of the first and second preferred embodiments can be directly mounted within the outer casing 106 adjacent to the air inlet 108 so as to increase the volume of air flowing into the air inlet 108.

In all the aforesaid preferred embodiments, the reason to dissipate heat resides in the volume of air within the electronic apparatus. Whenever, the air density within the electronic apparatus is increased, the ventilation thereof is enhanced so as to cause an air circulation within the electronic apparatus to expel heat to the external atmosphere. No noise will be generated by the use of the air-density increasing device of the present invention.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An electronic apparatus comprising:
an outer casing having an air inlet and an air outlet;
an exhaust fan mounted on said outer casing adjacent to said air outlet for drawing out air from said outer casing; and
an air-density increasing device mounted on said outer casing adjacent to said air inlet to enable the amount of air flowing into said air inlet to be greater than the amount of air that flows out of said air outlet, thereby increasing the density of air within said outer casing.

2. The electronic apparatus according to claim 1, wherein said air-density increasing device includes a thermoelectrical chip to lower the temperature of air passing therethrough, and to reduce the volume of the air so as to increase the air density.

3. The electronic apparatus according to claim 2, wherein said air-density increasing device further includes a suction fan to draw external air into said outer casing so as to increase the volume of air passing through said air inlet into said outer casing.

4. The electronic apparatus according to claim 1, wherein said air-density increasing device includes a suction fan to draw external air into said outer casing so as to increase the volume of air flowing into said air inlet so that the amount of air flowing into said air inlet is greater than the amount of air flowing out from said air outlet.

5. The electronic apparatus according to claim 1, wherein said air-density increasing device includes a guide passage to guide air to a predetermined location within said outer casing so as to increase the air density at said predetermined location.

6. An air-density increasing device for an electronic apparatus for increasing the density of air within the electronic apparatus, the electronic apparatus having an air inlet, an air outlet, and an exhaust fan disposed adjacent to the air outlet, the air-density increasing device being disposed at the air inlet, wherein activation of the exhaust fan ventilates the electronic apparatus, and causes air to flow into the electronic apparatus via the air-density increasing device to increase the density of air within the electronic apparatus and so as to expel air via the exhaust fan, the air-density increasing device comprising:
an external casing enclosing components of the air-density increasing device;
an air entrance which has at least one opening at a first end of said external casing for permitting air to flow thereinto;
a pressure increasing system for causing the amount of air flowing into the air inlet to be greater than the amount of air flowing out from the air outlet so as to increase the density of air within the electronic apparatus; and
a passage that is defined by at least one opening disposed at a second end of said external casing and that communicates with the air inlet so as to permit air flow into the electronic apparatus via said pressure increasing system.

7. The air-density increasing device for an electronic apparatus according to claim 6, wherein said pressure increasing system includes a thermoelectrical chip which lower the temperature of air passing therethrough so as to reduce the volume of air within said external casing and to increase air density.

8. The pressurization device for an electronic apparatus according to claim 7, wherein said pressure increasing system further includes a suction fan that is capable of suctioning air into the electronic apparatus so as to increase the volume of air passing through said air inlet.

9. The pressurization device for an electronic apparatus according to claim 6, wherein said pressure increasing system includes a suction fan that is capable of suctioning air into the electronic apparatus so as to increase the volume of air flowing into said air inlet so that the amount of air flowing into said air inlet is greater than the amount of air flowing out from said air outlet.

10. The air-density increasing device for an electronic apparatus according to claim 6, further comprising a guide passage that is disposed at adjoining position of said passage and said air inlet, that guides air into a predetermined location within the electronic apparatus and that is adapted to increase the air density at said predetermined location.

11. An electronic apparatus comprising:
an outer casing having an air inlet;
a closed pressure increasing casing having an air entrance and a passage, said air entrance being in spatial communication with said air inlet of said outer casing, said passage being in spatial communication with an interior of said outer casing;
at least one suction fan disposed at adjoining position of said air entrance and said passage for drawing air into said pressure increasing casing so as to increase the air density within said pressure increasing casing; and
at least one thermalelectric cooling chip mounted on said pressure increasing casing between said suction fan and said air entrance for lowering the temperature of air passing through said pressure increasing casing.

12. The electronic apparatus according to claim 11, wherein said outer casing has an air outlet, said electronic apparatus further comprising a suction fan disposed at said air outlet for drawing out air from said outer casing so that the amount of air flowing into said air inlet is greater than the amount of air flowing out from said air outlet.
